(19) United States
(12) Patent Application Publication
(10) Pub. No.: US 2014/0143055 A1
(43) Pub. Date: May 22, 2014

(54) IN-STORE MERCHANDISE OFFER SYSTEM

(71) Applicant: John R. Johnson, Charlotte, NC (US)

(72) Inventor: John R. Johnson, Charlotte, NC (US)

(21) Appl. No.: 14/060,229

(22) Filed: Oct. 22, 2013

Related U.S. Application Data
(60) Provisional application No. 61/728,000, filed on Nov. 19, 2012.

(51) Int. Cl. G06Q 30/02

(52) U.S. Cl. CPC G06Q 30/0257
USPC 705/14.55

(57) ABSTRACT

Embodiments of the invention are directed to systems, methods and computer program products for providing in-store merchandise offers. An exemplary system is configured to: receive an offer request from a consumer that indicates the consumer's interest in purchasing a product exhibited in an in-store merchandise showroom and determine product offers based on the request. The consumer is sent offers, where at least one of the offers is related to a merchant not associated with the merchandise showroom. The consumer is then provided an option to select at least one offer. Selecting an offer is equated to accepting one or more terms and conditions associated with the offer, and not selecting an offer is associating with denying one or more terms and conditions associated with the offer. After a selection is made the system receives the consumers offer selection.

### CLAIM OF PRIORITY UNDER 35 U.S.C. §119

This Non-provisional patent application claims priority to Provisional Patent Application Ser. No. 61/728,000 titled “In-Store Merchandise Offer System” filed on Nov. 19, 2012 hereby expressly incorporated by reference herein.

### BACKGROUND

Consumers are beginning to rely on web based solutions as an alternative to traditional in-store shopping. As a result, electronic commerce has expanded the focus of large retailers by offering on-line purchasing as a method for providing a broader assortment of products and pricing options to consumers. Typically, this occurs outside of the retail establishment which in turn eliminates in-store merchandising and promotion opportunities.

Retailers are constantly exploring ways to communicate with their shoppers utilizing mobile technologies. Many applications focus on promotion messaging that encourages consumers to shop in their stores. Many mobile applications for shoppers are offered by third party service providers. While the service may vary they are typically offer based and utilize location services with the aid of zip codes and global positioning systems (GPS). These applications target interest such as store locators, weekly circulars, digital coupons or offers, generic item pricing, and the like.

Current technology offers consumer search options and the ability to find items, locate where they are offered and at what price. However, these pricing applications offer retailers little benefit unless they are a low price leader in the market. Therefore, there is a need for a system to provide competitive online sales results to a consumer in-store such that the consumer may purchase products in-store at online rates.

### BRIEF SUMMARY

Embodiments of the invention are directed to systems, methods, and computer program products for providing in-store merchandise offers. In an exemplary embodiment, the system may comprise an apparatus for providing in-store merchandise offers. The apparatus may have several components such as a memory, a processor, and a module stored in the memory, executable by the processor, and configured to execute one or more step.

In one embodiment, the module may be configured to receive an offer request from a consumer, send the consumer one or more offers based at least partially on the offer request, provide the consumer an option to select at least one offer, and receive the consumers' option selection.

In some embodiments, the module may be further configured to: send the offer request to a merchant, and send competitor information to the merchant. In some embodiments, sending the consumer one or more offers may comprise the module being further configured to receive a merchant offer, and send the merchant offer to the consumer.

In some embodiments, the option selection may indicate the consumer is accepting at least one offer. In some embodiments, the module may be further configured to generate a transaction code based at least partially on the consumer option selection, and send the transaction code to the consumer.

In some embodiments, the option selection may indicate the consumer is not accepting at least one offer. In some embodiments, sending the consumer one or more offers may comprise the module being further configured to receive a second merchant offer based at least partially on the consumer option selection, and send the second merchant offer to the consumer.

In some embodiments, the module may be further configured to create at least one offer based at least partially on one or more business rules provided by a merchant.

In some embodiments, the one or more offers are sent to a mobile device associated with the consumer.

In an exemplary embodiment, a method for providing in-store merchandise offers may be provided. The method may comprise several steps such as receiving an offer request from a consumer, sending the consumer one or more offers based at least partially on the offer request, providing the consumer an option to select at least one offer, and receiving the consumers' option selection.

In some embodiments, the method may further comprise sending the offer request to a merchant, and sending competitor information to the merchant. In some embodiments, sending the consumer one or more offers may further comprises receiving a merchant offer, and sending the merchant offer to the consumer.

In some embodiments, the option selection indicates the consumer is accepting at least one offer. In some embodiments, the method may further comprise generating a transaction code based at least partially on the consumer option selection, and sending the transaction code to the consumer.

In some embodiments, the option selection indicates the consumer is not accepting at least one offer. In some embodiments, sending the consumer one or more offers may further comprise receiving a second merchant offer based at least partially on the consumer option selection, and sending the second merchant offer to the consumer.

In some embodiments, the method may further comprise creating at least one offer based at least partially on one or more business rules provided by a merchant.

In some embodiments, the one or more offers may be sent to a mobile device associated with the consumer.

In an exemplary embodiment, a computer program product for providing in-store merchandise offers may be provided. The computer program product may comprise several components such as a non-transitory computer-readable medium comprising a set of codes for causing a computer to execute one or more steps. In one embodiment, the set of code may cause a computer to receive an offer request from a consumer, send the consumer one or more offers based at least partially on the offer request, provide the consumer an option to select at least one offer, and receive the consumers' option selection. In another embodiment the computer program product may further comprise a set of codes for causing a computer to send the offer request to a merchant, and send competitor information to the merchant.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

### BRIEF DESCRIPTION OF THE DRAWINGS

Having thus described embodiments of the invention in general terms, reference will now be made to the accompanying drawings, where:

FIG. 1 is a diagram illustrating an in-store merchandise offer system environment, in accordance with embodiments of the present invention;

FIG. 2 is a flow diagram illustrating a process for providing in-store merchandise offer, in accordance with embodiments of the present invention;

FIG. 3 is a flow diagram illustrating a process for providing in-store merchant offers, in accordance with embodiments of the present invention;

FIG. 4 is a flow diagram illustrating a process for initiating a transaction based on an in-store merchandise offer, in accordance with embodiments of the present invention;

FIG. 5 is a block diagram illustrating high level use cases for providing in-store merchandise offers, in accordance with embodiments of the present invention;

FIG. 6 is a block diagram illustrating a process for combating show rooming, in accordance with embodiments of the present invention;

FIG. 7 is a block diagram illustrating a process for eliminating rain checks, in accordance with embodiments of the present invention;

FIG. 8 is a block diagram illustrating a process for in-hand warehousing, in accordance with embodiments of the present invention; and

FIG. 9 is a block diagram illustrating a process for transaction processing, in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Where possible, any terms expressed in the singular form herein are meant to also include the plural form and vice versa, unless explicitly stated otherwise. As used herein a “consumer” refers to a previous consumer or a non-consumer of one or more merchants or entities associated with one or more merchants. Furthermore, as used herein, the term “product” shall mean one or more goods, services, events, etc. that may be offered by a merchant. In addition, the term “offer” is used herein to denote any form of offer, promotion, rebate, coupon, incentive, reward, deal, loyalty program and/or the like offered for the purchase, lease, and/or the like of a product. A “coupon” as used herein may refer to a deal and/or the like of a product. A “transaction” as used herein may refer to a purchase, lease, barter, and/or any other form of transfer of product from a merchant to a consumer. A “merchant” as used herein may refer to a manufacturer, retailer, service provider, event provider, warehouse, supplier, and/or the like. Furthermore, as used herein, the terms “merchant” and “retailer” may be used interchangeably throughout the specification. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein, “based on” means “based at least in part on” or “based at least partially on.”

Various embodiments or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

Embodiments of the invention are directed to systems, methods and computer program products for providing in-store merchandise offers. The invention enables an entity to provide consumers with promotional information such that a merchant can compete with other retailers and make an in-store offer based on the competition, where the consumer can accept the offer in real-time.

As an example, a consumer may enter a merchant location and locate a product of interest. The consumer may then present a form of indicia to a mobile application, where the indicia is related to the product of interest and indicates several items of information about the product. The mobile application may then transmit the information to an application server such that the system can provide the consumer a plurality of alternative offers related to the product. The alternative offers may be associated with other merchant locations and/or online retailers allowing the consumer to decide which offer reflects the best value for the product of interest.

The system may also communicate the consumers' interest in the product to the merchant where the consumer is located. In this way, the merchant is equally capable of providing a plurality of offers for presentation to the consumer along with the other retailers. The system may further provide the merchant information about the competitors current pricing and promotional offers allowing the merchant to develop an offer to present to the consumer that is highly competitive in respect to other retailers. This may encourage the consumer to make an in-store purchase versus leaving and purchasing the product of interest elsewhere. Upon a consumer acceptance of an offer the consumer may be provided a barcode which can be presented to the merchant using the consumers' mobile device, where the barcode is shown on a display associated with the consumers' mobile device. The merchant may then scan the barcode and process the consumer's transaction. The barcode may encompass several items of information including, but not limited to, information related to the product, information related to the accepted offer, and payment information associated with the consumer.

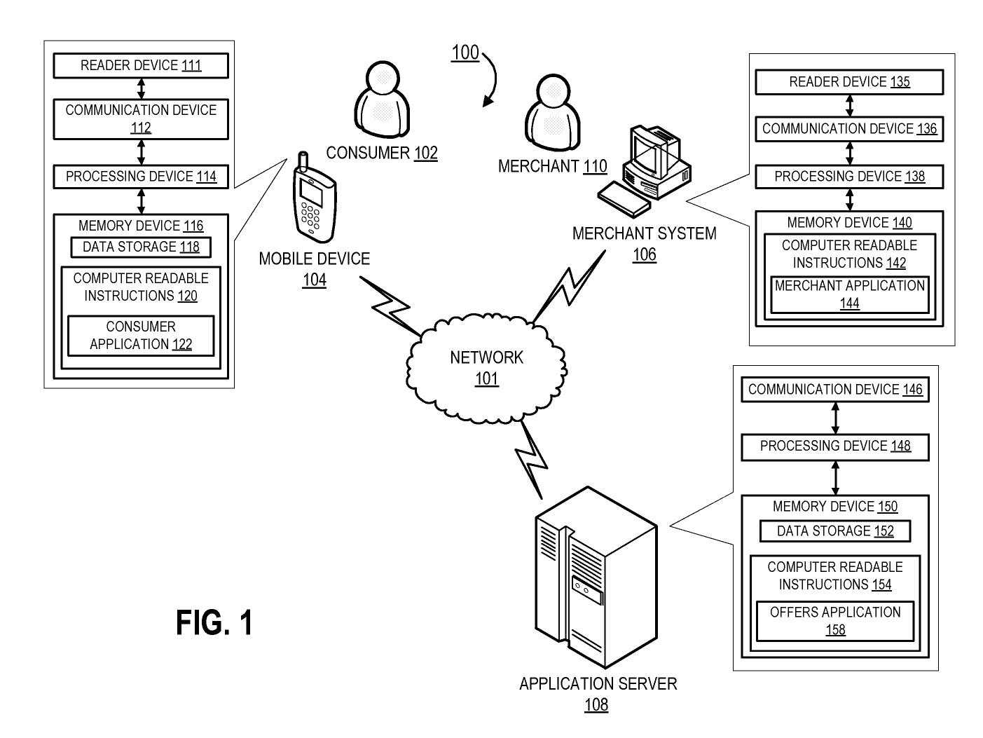

FIG. 1 provides in-store merchandise offers system environment 100, in accordance with one embodiment of the present invention. As illustrated in FIG. 1, the application server 108 is operatively coupled, via a network 101 to the mobile device 104, and to the merchant system 106. It should be noted that merchant systems could include both a merchant account interface as well as a merchant end system, such as a cash register, point-of-sale terminal, or the like. It should also be noted, in some embodiments the mobile device 104 may be interchanged with other end consumer systems, such as a computer, tablet, or the like. In this way, the application server 108 can send information to and receive information from the mobile device 104 and the merchant system 106 to match and provide shopper-specific offers to a consumer 102. FIG. 1 illustrates only one example of an embodiment of an in-store merchandise offers system environment 100, and it will be appreciated that in other embodiments one or more of the systems, devices, or servers may be combined into a single system, device, or server, or be made up of multiple systems, devices, or servers.

The network 101 may be a global area network (GAN), such as the Internet, a wide area network (WAN), a local area network (LAN), or any other type of network or combination of networks. The network 101 may provide for wireline, wireless, or a combination wireline and wireless communication between devices on the network.

In some embodiments, the consumer 102 is an individual processing a transaction or considering a transaction with the merchant. The transaction may be made at a merchant system 106 of a merchant, online or offline, over the phone, at the merchant's place of business and/or other transaction means. The purchase may be initiated by the consumer 102 using a mobile device 104, such as a mobile wallet (i.e. smart phone, PDA, etc.) or other types of payment systems that communicate with merchant systems 106 and/or application servers 108 to allow the merchant 110 to process a transaction. In other embodiments, the consumer 102 may make transactions using a card with stored magnetic information, digital information, or other like payment device that stores information that may be transferred to a merchant system 106 and/or an application server 108 to allow a consumer 102 to make a transaction, such as a credit card, debit card, gift card, and/or the like. In some embodiments, the merchant 110 may be a merchant or a person, employee, agent, independent contractor, etc. acting on behalf of the merchant to enter process a transaction.

As illustrated in FIG. 1, the application server 108 generally comprises a communication device 146, a processing device 148, and a memory device 150. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 148 is operatively coupled to the communication device 146 and the memory device 150. The processing device 148 uses the communication device 146 to communicate with the network 101 and other devices on the network 101, such as, but not limited to the merchant system 106 and the mobile device 104. As such, the communication device 146 generally comprises a modem, server, or other device for communicating with other devices on the network 101.

As further illustrated in FIG. 1, the application server 108 comprises computer-readable instructions 154 stored in the memory device 150, which in one embodiment includes the computer-readable instructions 154 of an offers application 158. In some embodiments, the memory device 150 includes data storage 152 for storing data related to the offers application 158 including but not limited to data created and/or used by the offers application 158 or the information of consumers 102. The data storage 152 may also store all offers provided by merchant systems 106 such that the offers application 158 may match the offers stored with a consumer's 102 interest.

In the embodiment illustrated in FIG. 1 and described throughout much of this specification, the offers application 158 allows the consumer 102 to interact with the system. First, the offers application 158 allows a consumer 102 to search for competitive pricing for a product of interest, via the mobile device 104. Next, the offers application 158 allows the merchant 110 to manually input offers related to products the consumer 102 may wish to purchase, via the merchant system 106. Both searching for competitive pricing and manually inputting product offers may be performed by a using an interface, such as a mobile device 104 or merchant system 106, provided from the offers application 158 via a network 101.

In some embodiments, the offers application 158 allows the consumer 102 to communicate, via the mobile device 104, to indicate products that the consumer 102 may wish to purchase. This communication may be in the form of text communications, voice communications, or the like. Typically, offers for products the consumer 102 may wish to purchase may be provided by the merchant 110 through an interface on the mobile device 104, such as that illustrated in FIG. 1. The offers application 158 may receive the product offers from the merchant system 106 once the merchant 110 has inputted the products onto the interface. It should be noted that the merchant 110 may refer to a merchant associated with a merchant store where a consumer 102 is currently shopping for a product of interest, while other merchants where the consumer 102 is not currently located may also be generally mentioned.

The in-store offers provided may be more beneficial to a consumer 102 than other offers that may be provided by online merchants. This is largely due to the ability to provide the merchant 110 with product-specific information related to offers provided by other retailers in competition with the merchant 110. In this way, the offers may entice the consumer 102 to make an in-store purchase based upon the real-time offer provided by the merchant 110 versus leaving and shopping at a merchant different than the one he/she is currently shopping with. These additional discounts for products may be passed on to the consumers 102 based at least partially on the consumer indicating an interest in the product while in the show room of the merchant 110. Thereafter, the consumer 102 may frequent the merchant's 110 in-store location more often based upon the ability to receive additional offers while shopping in-store. The offers provided through may comprise special offers that are exclusively provided to the consumer 102 from the merchant 110. In this way, the consumer 102 may receive more beneficial offers through completing transactions with the merchant 110 than any other retail location.

The merchant 110, through the merchant system 106, may provide the offers application 158 data with respect to the offers available. The offers application 158 may then store the data related to the merchant 110 offer such as, but not limited to the product, the offer, the location for the offer, business rules associated with offers etc. In this way, the offers application 158 may have access to all offers available from all merchants 110, in a database, to utilize when matching the consumer 102 with one or more offers.

The offers application 158 may also receive data from the merchant system 106. The merchant system 106, as explained in further detail below, allows the offers application 158 to determine the location of the merchant 110 such that it can be matched with a recent product interest of the consumer 102. Because the merchant system 106 may send authentication for a consumer 102 transaction to the application server 108 or other application servers, the offers application 158 may receive data regarding the transaction from the application server 108 or the other application servers. In this way, the offers application 158 may determine and store in the data storage 152 information relating to the location of the potential transaction and the products of the potential transaction. The location of the potential transaction may be determined due to the merchant system location or other means such as global positioning systems (GPS), mobile device 104 locators, or the like. In some embodiments, the location data is determined by a merchant system 106. In this way the location data may be analyzed to verify the consumer 102 is within the specific area. In this way, the location data provided by the merchant system 106 to the offers application 158 may aid in providing the consumer 102 offers for products from merchants within a merchant area and/or online. In some embodiments, the merchant area may be the same merchant area the consumer 102 is currently shopping. In some embodiments the merchant area may be a different merchant area than the one the consumer 102 is currently shopping. The location data may also aid the offers application 158 in notifying the merchant 110 that an interested consumer 102 has left the merchant area.

In some embodiments, the location of the consumer 102 may not be required for the offers application 158 to provide offers from the merchant 110 to the consumer 102. In this example, the merchant 110 offer may be provided by the consumer 102 scanning a barcode related to the item in which they are interested. The barcode may also be encoded such that it has location information associated with the current location of the product. In this way, the offers application 158 is notified of the product location in response to the barcode being scanned. To this extent, the offers application 158 may provide the consumer 102 offers from the merchant 110 in relation to other pricing options available for the product at alternative locations. In other embodiments, the consumer 102 may specify the area from which they want to receive pricing options. In one embodiment, pricing option may be provided from online retailers. In another embodiment, pricing options may be provided by other merchants within an area similar to merchant 110.

The data stored within the offers application 158 provides computer readable instructions 154 to the processing device 148 to allow for the matching of an offer received from a merchant system 106 with a consumer 102 based on the consumer's 102 location data and search request data. The offers application 158 stores the matched offers and communicates the offers to a consumer 102 via a network 101 to the consumer's 102 mobile device 104.

Matching offers provided by merchants 110 with consumers 102 may require an analysis of the consumer's 102 search requirements. The search requirement may indicate a product of interest and one or more characteristics associated with the products of interest, such as particular product specifications. The offers application 158 may provide an offer to a consumer 102 based on a combination of factors. Furthermore, if more than one pricing option is being presented to the consumer 102, the merchant 110 may present an additional offer supplementing the current in-store price, thus enticing the consumer 102 to complete the purchase where the real-time offer is being provided to the consumer 102. The offers application 158 uses these factors to determine which offers from merchants 110, the offers stored in a database in data storage 152, are appropriate offers for the consumer 102. In some embodiments, the offer may be for products that it may be determined that the consumer 102 may be interested in. In some embodiments, the offer may be for a merchant where the consumer 102 is currently located. In yet other embodiments, the offer may be for a merchant area that the consumer 102 may not frequent and/or may have to travel to.

The consumers 102 location may be determined by the offers application 158 through location data. Location data may be established by data sent from the merchant system 106, GPS data associated with the consumer 102 or the consumer's 102 mobile device 104, transaction history data, etc. stored in the application server 108 and the like. For example, a merchant system 106 may be used by a consumer 102 at a merchant 110 to complete a transaction. Along with the authentication data needed to authenticate the payment for the purchase of a product, the merchant system 106 may also send information as to the location of the merchant 110 to the offers application 158. Therefore, the offers application 158 may receive address information or at least general geographic indication information for the merchant 110 where the consumer 102 just completed a transaction. Location data may also be received by the offers application 158 from a mobile device 104 of a consumer 102, the merchant 110, GPS data, or the like. In this way, the location of the consumer 102 may be known, even if the consumer 102 is not making a purchase. Therefore an offer may be provided to the consumer 102 at any time, independent of the consumer 102 making a transaction.

As illustrated in FIG. 1, the merchant system 106 generally comprises a reading device 135, a communication device 136, a processing device 138, and a memory device 140. The reading device 135 is operatively coupled to the processing device 138, communication device 136, and the memory device 140. The merchant system 106 may include a reader device 135 to receive payment account information from the consumer 102 through the mobile device 104 and/or other payment devices. Such a reader device 135 may include a magnetic strip reader, a barcode scanner, a radio frequency (RF) reader, a character recognition device, a magnetic ink reader, a processor for interpreting codes presented over an electrical or optical medium, a biometric reader, a wireless receiving device, and/or the like. In some embodiments, the reading device 135 receives information that may be used to identify the consumer's 102 payment account and/or transaction data at the merchant system 106 and communicates the information via the communication device 136 over a network 101, to other systems such as, but not limited to the application server 108, other systems, and/or the commercial partner systems. As such, the communication device 136 generally comprises a modem, server, or other device for communicating with other devices on the network 101.

As further illustrated in FIG. 1, the merchant system 106 comprises computer-readable instructions 142 stored in the memory device 140, which in one embodiment includes the computer-readable instructions 142 of a merchant application 144. A merchant system 106 may refer to any device used to perform a transaction, either from the consumer's 102 perspective, the merchant's 110 perspective or both. In some embodiments, the merchant system 106 may refer only to a consumer's device, in other embodiments it refers only to a merchant device, and in yet other embodiments, it refers to both a consumer device and a merchant device interacting to perform a transaction. For example, in one embodiment, the merchant system 106 refers to the consumer's 102 mobile device 104 configured to communicate with a merchant's point of sale terminal, whereas in other embodiments, the merchant system 106 refers to the merchant's point of sale terminal configured to communicate with a consumer's 102 mobile device 104, and in yet other embodiments, the merchant system 106 refers to both the consumer's mobile device and the merchant's point of sale terminal configured to communicate with each other to carry out a transaction.

In some embodiments, a merchant system 106 is or includes an interactive computer terminal that is configured to initiate, perform, complete, and/or facilitate one or more transactions. A merchant system 106 could be or include any device that a consumer may use to perform a transaction with an entity, such as, but not limited to, a magnetic-based payment device (e.g., a credit card, debit card, etc.), a personal identification number (PIN) payment device, a contactless payment device (e.g., a key fob), a radio frequency identification device (RFID) and the like, a computer, (e.g., a personal computer, tablet computer, desktop computer, server, laptop, etc.), a mobile device (e.g., a smartphone, cellular phone, personal digital assistant (PDA) device, MP3 device, personal GPS device, etc.), a merchant terminal, a self-service machine (e.g., vending machine, self-checkout machine, etc.), a public and/or business kiosk (e.g., an Internet kiosk, ticketing kiosk, bill pay kiosk, etc.), a gaming device, and/or various combinations of the foregoing.

In the embodiment illustrated in FIG. 1, the merchant application 144 allows the merchant system 106 to be linked to the application server 108 to communicate, via a network 101, the information related to the transaction being made, such as the transaction type, cost of transaction, product type, merchant location, consumer 102 location, etc. In this way, the merchant application 144 may provide the offer application 158 with location data and recent transaction data, such that the offer application 158 may determine appropriate geographic information to associate with the offer match for the consumer 102. In one example, the consumer 102 enters into a transaction at a merchant system 106, which processes the transaction and the merchant application 144 allows communication of the transaction information to the application server 108.

The merchant application 144 may also receive information from the application server 108. The merchant application 144, in some embodiments, may receive an offer or offers from the offers application 158, such that they merchant application 144 may display the offer or offers to the consumer 102 on a display on the merchant system 106. In this way, the consumer 102 may receive an offer to purchase the product that the consumer 102 is already in the process of purchasing with an online merchant. The offer may be displayed on the merchant system 106 such that the consumer 102 may accept the offer prior to the completion of the transaction.

FIG. 1 also illustrates a mobile device 104. The mobile device 104 generally comprises a reader device 111, communication device 112, a processing device 114, and a memory device 116. The reading device 111 is operatively coupled to the processing device 114, communication device 112, and the memory device 116. The mobile device 104 may include a reader device 111 to receive product information from the merchant 110. Such a reader device 111 may include a magnetic strip reader, a barcode scanner, a radio frequency (RF) reader, a character recognition device, a magnetic ink reader, a processor for interpreting codes presented over an electrical or optical medium, a biometric reader, a wireless receiving device, and/or the like. In some embodiments, the reading device 111 receives information that may be used to identify the merchant's 110 offer data at the merchant system 106 and communicates the information via the communication device 112 over a network 101, to other systems such as, but not limited to the application server 108, the merchant system 106, and/or other systems. The processing device 114 is likewise operatively coupled to the communication device 112 and the memory device 116. The processing device 114 uses the communication device 112 to communicate with the network 101 and other devices on the network 101, such as, but not limited to the merchant system 106 and the application server 108. As such, the communication device 112 generally comprises a modem, server, or other device for communicating with other devices on the network 101.

As further illustrated in FIG. 1, the mobile device 104 comprises computer-readable instructions 120 stored in the memory device 116, which in one embodiment includes the computer-readable instructions 120 of a consumer application 122. In this way, a consumer 102 may be able to receive offers, deny offers, accept offers, make payments for transactions, and/or the like using the consumer application 122. Furthermore, the mobile device 104 comprises a data storage 118 application within the memory device 116 to store data associated with the mobile device 104. A “mobile device” 104 may be any mobile communication device, such as a cellular telecommunications device (i.e., a cell phone or mobile phone), personal digital assistant (PDA), a mobile Internet accessing device, or other mobile device including, but not limited to portable digital assistants (PDAs), pagers, mobile televisions, gaming devices, laptop computers, cameras, video recorders, audio/video player, radio, GPS devices, any combination of the aforementioned, or the like. Although only a single mobile device 104 is depicted in FIG. 1, the in-store merchandise offer system 100 may contain numerous mobile devices 104.

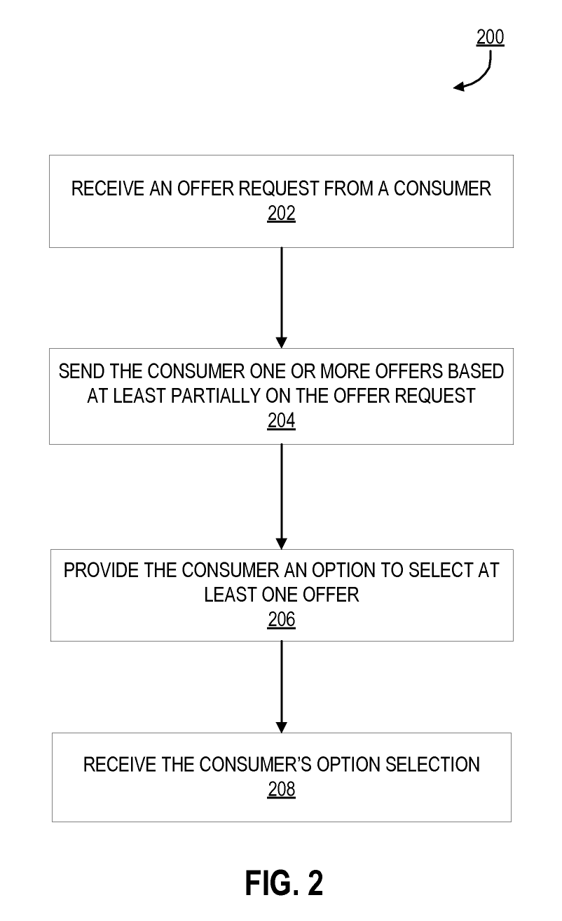

Referring now to FIG. 2, a flow diagram illustrating a process for providing in-store offers for merchandise 200, in accordance with embodiments of the present invention, is provided. At event 202, the system may receive an offer request from the consumer 102. The offer request may indicate the consumers 102 interest in one or more products showcased in the merchant 110 store. Receiving an offer request may comprise sending information via a consumer application 122 to the application server 108 to indicate the consumers 102 interest in a product. An offer request may be received in response to the consumer 102 scanning a code associated with the product. The code may be scanned using the reader device 111 associated with the mobile device 104. In one embodiment, the product code may be a one-dimensional code such as a barcode. In another embodiment, the product code may be a two-dimensional code such as a Quick Response (QR) code. An offer request may be received in response to the consumer 102 entering product information into the consumer application 122 such that the product information is sent to the application server 108. Product information may comprise the product(s) name, manufacturer, make/model, characteristics (e.g. color, size, etc.), location, skew number, cost, and the like. In one embodiment, product information may be presented in the form of an alphanumeric code, such that the consumer 102 enters the alphanumeric code into the consumer application 122 and product information is sent to the application server 108 indicating the consumers 102 interest in the related product. In another embodiment, the product code and/or product information may be used for the offers application 158 to recognize a specific product of interest and alert the merchant 110.

The consumer 102 may specify the types of offers in which they want to request. In one embodiment, the consumer 102 may specify that they want to receive the best offers available for a product. The best offer may reflect the offer which indicates the lowest cost for a specific product. The best offer may also reflect the offer which indicates the closest location for a specific product. In another embodiment, the consumer 102 may specify that they want to receive money-saving offers. Money-saving offers may comprise offers that provide coupons, discounts, rebates and the like.

At event 204, the system may send the consumer 102 one or more offers based at least partially on an offer request received from the consumer 102. The one or more offers may be related to a plurality of merchants which offer the product of interest. In one embodiment, the merchants may be other in-store retailers located within a specific area. In another embodiment, the merchants may be online retailers. In yet another embodiment, the merchants may be a combination of both in-store retailers and/or online retailers. In one example, the consumer 102 may request the best offers available for a product. As such, the application server 108 may analyze the product information and retrieve a range of offers, related to the product of interest, that are available. In return, the system may send the consumer 102 one or more offers which reflect the best value for the product. In another example, the consumer 102 may request to receive money-saving offers available for a product. As such, the application server 108 may analyze the product information and retrieve a range of offers, related to the product of interest, that are available for immediate in-store use. In return the system may send the consumer 102 one or more offers which indicate money-saving options, such as coupons, for the consumer 102 to immediately use. In such an embodiment, the coupon may be applied to the consumers 102 purchase while processing the transaction.

Sending the consumer 102 one or more offers may further comprise retrieving the one or more offers stored in the application server 108. Offers may be generated by a plurality of means and stored in the application server 108 for later use in matching product offers with consumer 102 product interest. Offers may also be generated in real-time such that the offers are available for immediate use. Offers may be retrieved from online sources, merchants, corporations, manufactures, and/or be consumer specific generated offers. Online offers may be generated based upon online coupon and/or product searches. Merchant offers may be generated based upon flyers/circulars, in-store offers, inventory, pricing, transaction history, and the like. Corporate offers may be generated based upon online retailer offers, inventory, online pricing options, delivery options, timing of interest, various product related fees, and the like. Manufacturer offers may be generated based upon direct custom offers, unadvertised offers, and the like. Consumer specific offers may be generated based upon purchase history, merchant loyalty, and the like. In another embodiment, the system may use web scraping mechanisms to locate the best offers available.

At event 206, the system may provide the consumer 102 an option to select at least one of the offers sent to the consumers' mobile device 104. In one embodiment, each offer may be individually displayed on the consumers' mobile device 104 along with an option to accept or deny the offer. In another embodiment, one or more offers may be collectively displayed on the consumers' mobile device 104 along with an option to accept or deny the one or more offers. In such an embodiment, the consumer may be able to select multiple offers and choose an option which states “accept all” or “deny all”. In one embodiment, failing to explicitly accept or deny any an offer may be equated to denying the offer. At event 208, the system may receive the consumer's 102 option selection such that the system is provided information indicating whether the consumer 102 has chosen to accept and/or deny one or more of the offers presented.

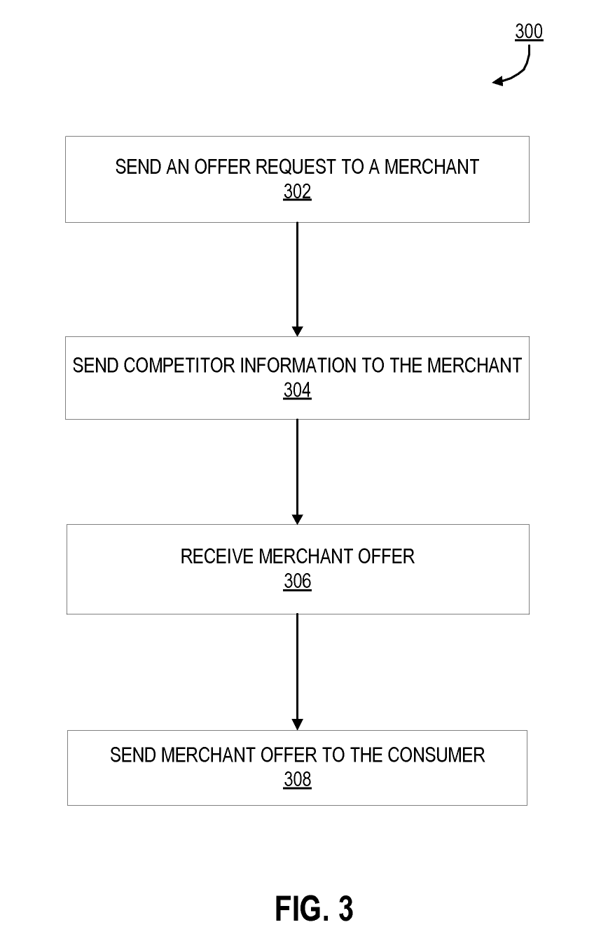

Referring now to FIG. 3, a flow diagram illustrating a process for providing in-store merchant offers 300, according to an embodiment of the present invention, is provided. At event 302, the system may send the merchant 110 an offer request from the consumer 102. The offer request may indicate the consumers 102 interest in one or more products showcased in the merchant 110 store. Sending an offer request may comprise sending information via the application server 108 to the merchant system 106 to indicate the consumers 102 interest in a product. An offer request may be sent in response to the consumer 102 scanning a code associated with the product. An offer request may be sent in response to the consumer 102 entering product information into the consumer application 122 such that the product information is sent to the application server 108 and product interest is conveyed to the merchant 110. Product information may comprise the product(s) name, manufacturer, make/model, characteristics (e.g. color, size, etc.), location, skew number, cost and the like. In one embodiment, product information may be presented in the form of an alphanumeric code, such that the consumer 102 enters the alphanumeric code into the consumer application 122 and product information is sent to the merchant 110 indicating the consumers 102 interest in the related product.

At event 304, the system may send the merchant 110 competitor information associated with the product of interest. The competitor information may include current prices for the product at different merchant locations. The competitor information may be related to a plurality of merchants which offer the product of interest. In one embodiment, the merchants may be other in-store retailers located within a specific area. In another embodiment, the merchants may be online retailers. In yet another embodiment, the merchants may be a combination of both in-store retailers and/or online retailers. In one embodiment, the system may only list information associated with competitive retailers that have current prices for the product of interest that are less than or equal to the current price listed by the merchant 110. In another embodiment, the system may list information associated with retailers that have current prices for the product of interest that are less than, greater than, and/or equal to the current price listed by the merchant 110. In yet another embodiment, the system may only list information associated with competitive retailers that are located within in a specific geographic.

The merchant 110 may use the competitor information received to determine an offer to provide the consumer 102 in relation to the product of interest. The merchant 110 may create an offer to send to the consumer 102 based on at least one or more business rules. In one embodiment, the one or more business rules may be based at least partially on the retail margin. For example, the merchant 110 may take into consideration retail cost of the product of interest and compare it with the consumer 102 price to create a retail margin. In such an embodiment, the merchant 110 business rule may indicate that a product can be offered to the consumer for any discounted price where the discount does not exceed the amount of the retail margin. In this way, the merchant may compete with the best price provided by its competitors as long as the competitive offer price does not create a deficit in the retail margin. In one embodiment, the one or more business rules may be provided by the merchant 110 and stored in the application server 108 such that upon receiving an offer request for a product of interest the application server 108 can determine an appropriate offer to send the consumer 102 based on at least one of the business rules without first consulting the merchant 110. In another embodiment, the one or more business rules may indicate whether a product of interest should be shipped to the consumer 102 or available for pick-up. In some embodiments, the merchant offer includes a discounted price with relation to the competitor pricing and/or a purchase incentive for purchasing the product from the merchant such as free in-home delivery and setup, a percentage off a second item purchased, a monthly subscription service and/or the like.

After a merchant 110 offer has been created, at event 306, the merchant offer may be received by the application server 108. In one embodiment, receiving the merchant offer may comprise receiving the one or more business rules from the merchant 110 where the one or more business rules may be used to create a merchant offer on behalf of the merchant 110. In one embodiment the merchant offer is sent by the merchant system 106 and received by the application server 108.

At event 308, upon receiving a merchant offer the merchant offer may be sent to the consumer 102 such that the consumer may either accept or deny the offer being presented. In one embodiment, the merchant offer may be sent to the consumer by the application server 108 and displayed via the consumer application 122. In another embodiment, the merchant offer may be sent to the consumer 102 by the application server 108 via other forms of mobile communication such as text, mobile sms, email, and the like.

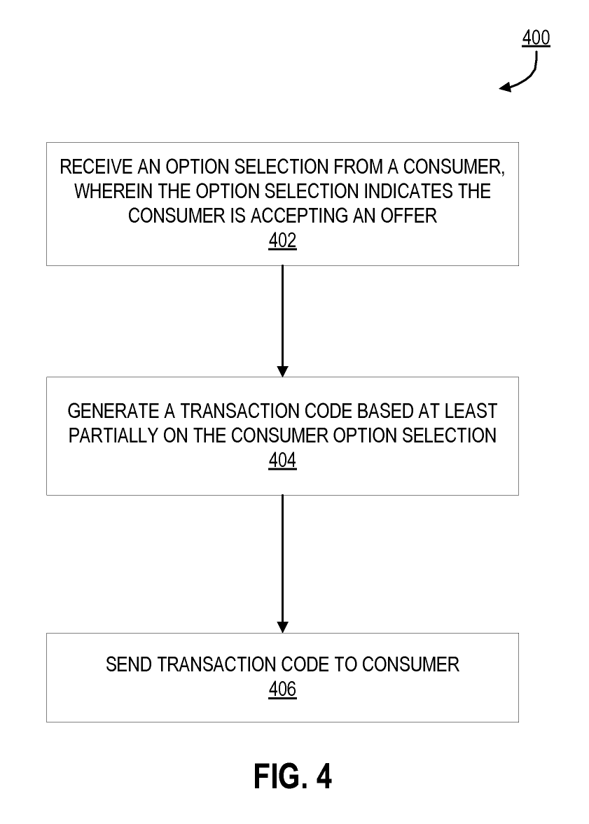

Referring now to FIG. 4, a flow diagram illustrating a process for initiating a transaction based on an in-store merchandise offer 400, according to an embodiment of the present invention, is provided. At event 402, the system may receive an option selection from a consumer 102. In one embodiment, the option selection may indicate that the consumer 102 has chosen to not accept one or more offers. In such an embodiment, the system may send the information to the merchant 110 such the merchant 110 can provide the consumer 102 another offer. The merchant 110 may choose to offer the consumer 102 the previous offer along with a supplemental offer. For example, the merchant 110 may initially offer the consumer 102 $100 off the product of interest, where the product of interest may be a television. In the instance that the consumer 102 chooses to not accept this offer, information indicating the denial of the offer may be sent to the application server 108 and conveyed to the merchant 110 such that the merchant 110 may choose to furthermore offer the consumer 102 a free DVD player in addition to the $100. In an alternative embodiment, the merchant 110 may choose to offer the consumer 102 an entirely new offer. In one embodiment, the merchant 110 may be informed about the option selection from the consumer 102 such that the option selection indicates the consumer 102 has chosen to accept an offer provided by another retail location and deny the offer provided by the merchant 110. In such an embodiment, the merchant 110 may resend the consumer 102 another offer prior to the consumer 102 completing a purchase with a competitive retail location. The offer may be instantaneously sent to the consumer 102 such that the consumer 102 receives the new offer from the merchant 110 prior to leaving the merchants' store. In one embodiment, the option selection may indicate that the consumer 102 has chosen accept one or more offers. In such an embodiment, the system may send the information to the merchant 110 such the merchant 110 can begin to initiate a checkout process for the consumer 102.

At event 404, the system may generate a transaction code based at least partially on the consumer choosing to the option to accept one or more offers. The transaction code may comprise information including, but not limited to, the product(s) name, product cost, product manufacturer, product make/model, product characteristics (e.g. color, size, etc.), product location, product skew number, offer discount, offer date, offer location, and the like. In another embodiment, the transaction code may include payment information associated with the consumer 102.

At event 406, the system may send the transaction code to the consumer 102. The transaction code may be sent to the consumer 102 by the application server 108 such that the transaction code can be view on a display associated with the consumers' 102 mobile device 104. The transactions code may be scanned using the reader device 135 associated with the merchant system 106. In one embodiment, the transaction code may be a one-dimensional code such as a barcode. In another embodiment, the transaction code may be a two-dimensional code such as a QR code. In yet another embodiment, the transaction code may be an alphanumeric code such as a coupon code. The transaction code may be presented by the consumer 102 and scanned by the merchant system 106 such that the transaction process is initiated in one form or another. In one embodiment, the merchant system 106 may receive the consumers' 102 payment information along with the detail of the offer accepted upon receiving the transaction code. In one embodiment, the transaction code may be time sensitive such that it may expire within a predetermined time period. The predetermined time period may be set with respects to a specified number of minutes, hours, days, weeks, months and the like. This may discourage the consumer 102 from leaving the merchant 110 location without making a same day purchase.

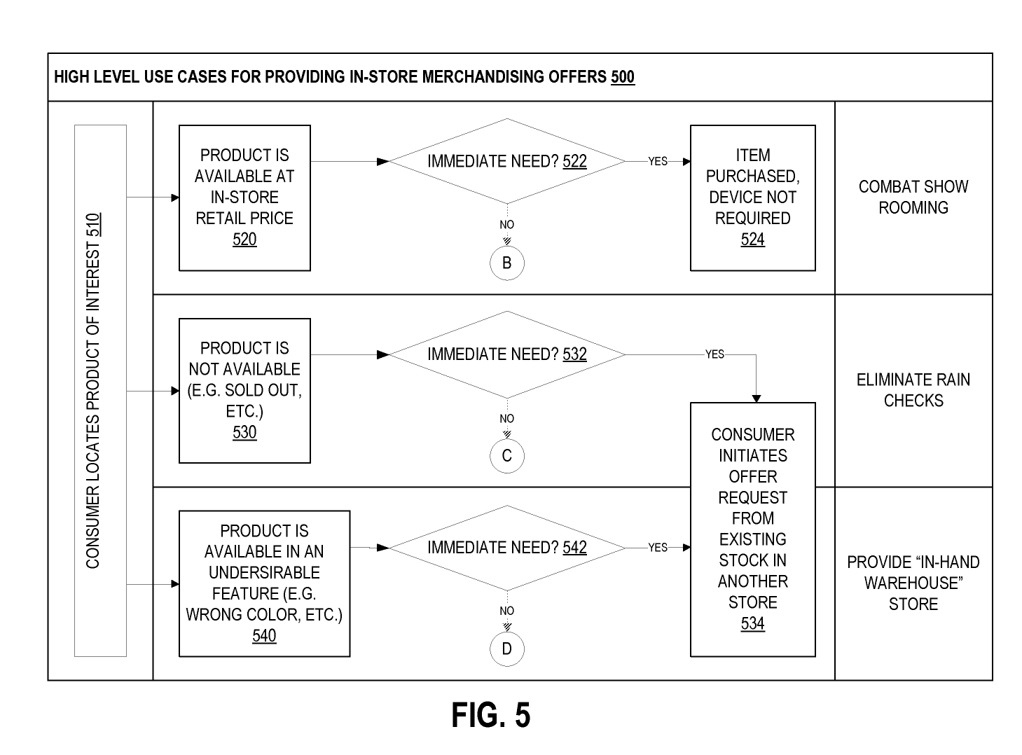

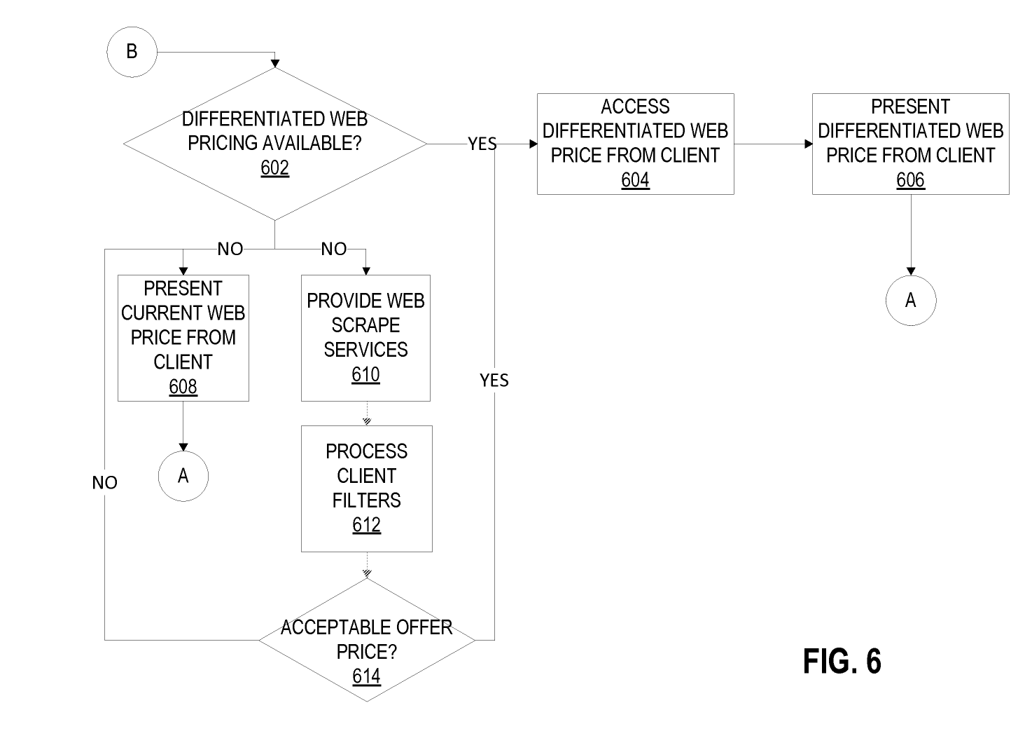

Referring now to FIG. 5, a block diagram illustrating high level use cases for providing in-store merchandise offers 500, according to an embodiment of the present invention, is provided. The system may be used in several different cases. In one embodiment, the system may be used to deter show rooming at a merchant 110 location. In such an embodiment, the consumer 102 may locate a product of interest 510 at the merchant location. If the product is available at the merchant location 520 the consumer 102 may or may not have an immediate need for the product 522. In an instance where the consumer 102 has an immediate need for the product, the consumer 102 may purchase the product without inquiring whether better deals exist for the product at competitive locations, as illustrated in even 524. In an instance where the consumer 102 does not have an immediate need for the product, the consumer 102 may inquire whether differentiated web pricing is available 602, as shown in FIG. 6. If differentiated web pricing is available the consumer 102 may access the differentiated web pricing from the system 604 such that the prices are presented 606 on the consumers' mobile device where the consumer 102 may either accept or deny an offer price 614 and proceed to complete a transaction with the merchant. In one embodiment, if differentiated web pricing is not available the system may present current web prices from the client 608. In another embodiment, if differentiated web pricing is not available the system may provide web scraping services 610 and process one or more client filters 612 such that the consumer may either accept or deny an offer price 614 and proceed to complete a transaction with the merchant. In an instance that the offer price is not acceptable 614 the system may present current web prices from the client 608 and allow the consumer 102 to proceed with processing a transaction with the merchant.

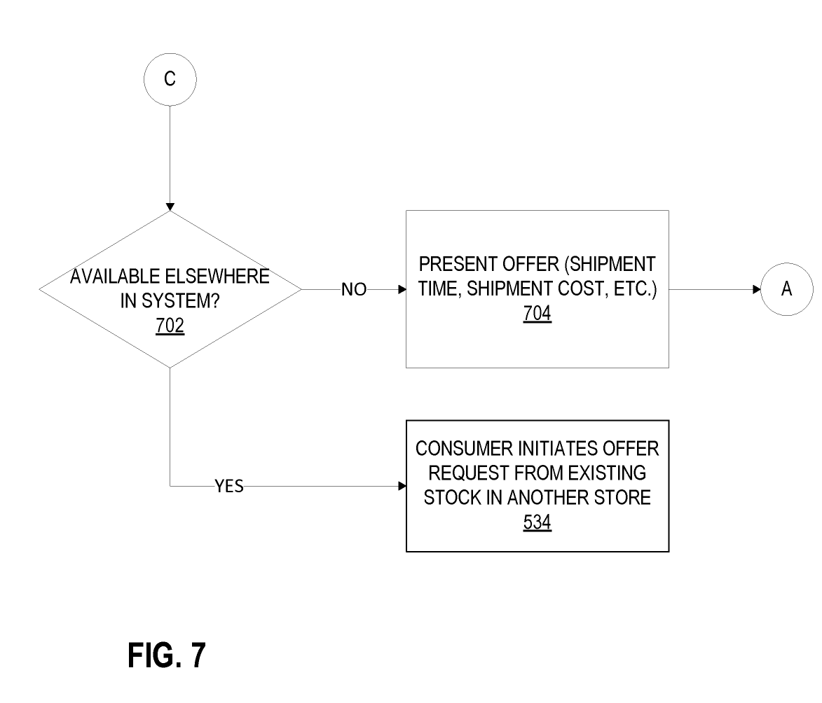

In another embodiment, the system may be used to eliminate rain checks at a merchant 110 location. In such an embodiment, the consumer 102 may locate a product of interest 510 at the merchant location. If the product is not available at the merchant location, as illustrated in event 530, the consumer 102 may or may not have an immediate need for the product 532. In an instance where the consumer 102 has an immediate need for the product, the consumer 102 may initiate an offer request from the existing stock in another retail location 534. In an instance where the consumer 102 does not have an immediate need for the product, the consumer 102 may inquire whether the product is available elsewhere in the system 702, as shown in FIG. 7. If the product is not available the consumer 102 may be presented an offer 704 by the merchant 110 where the offer may include shipping the product of interest to the consumer 102. The offer may include a shipment time, shipment cost, and the like such that the consumer 102 may either accept or deny an offer and proceed to complete a transaction with the merchant 110. In one embodiment, the consumer 102 may be required to pay for the product at the time of accepting the offer. In another embodiment, the consumer 102 may be allowed to pay for the product at a later date. In such an embodiment, the product may be shipped to the merchant store and available for pick-up on the arrival date such that the consumer 102 may pay for the product when it is picked up.

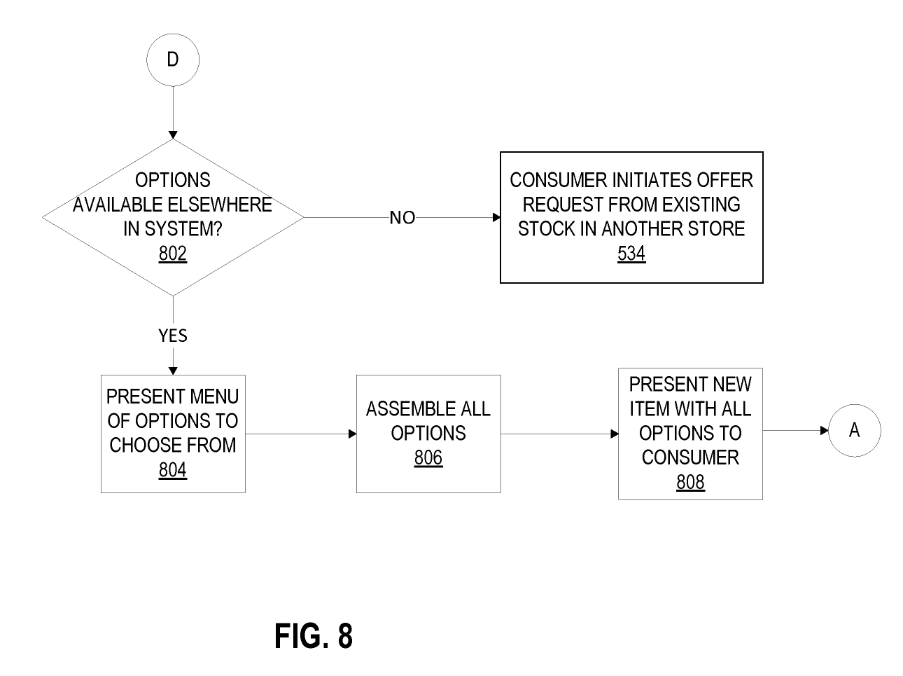

In yet another embodiment, the system may be used to provide in-hand warehousing at a merchant 110 location. In such an embodiment, the consumer 102 may locate a product of interest 510 at the merchant location. If the product is available at the merchant location in an undesirable feature 540 the consumer 102 may or may not have an immediate need for the product 542. For example the consumer 102 may desire a white smartphone of a specific make/model but the merchant may only have a black smartphone of the specific make/model in stock. In an instance where the consumer 102 has an immediate need for the product, the consumer 102 may initiate an offer request from the existing stock in another retail location 534. In an instance where the consumer 102 does not have an immediate need for the product, the consumer 102 may inquire whether the product options are available elsewhere in the system 802, as shown in FIG. 8. If the product is available the consumer 102 may be presented a menu of options to choose from 804. The options may then be assembled 806, and the consumer 102 may be presented with a new item including the assembled options 808 such that the consumer 102 may either accept or deny an offer and proceed to complete a transaction with the merchant 110.

In another embodiment, the system may provide a process that enables merchandise to be shipped from an alternative merchant location where the selected product is being sold at a slower rate versus being shipped from a central merchandising location, such as a warehouse. As such the system may be further configured to determine one or more merchant locations that have a surplus of the selected product and determine that the product is being sold at a slow rate. The system is capable of analyzing merchant store level margin/inventory movement with respect to any given product as criteria for determining from which location to ship goods.

For example, the system may first determine that the selected product is unavailable at the merchant location where the consumer is currently located. In response to receiving, from the consumer, an indication of interest in the selected product, the system may determine one or more alternative merchant locations that have the product in stock and have indicated based on inventory movement that the product is being sold at a slower rate. The system may then determine to ship the product to the customer from at least one alternative merchant location versus being shipped from a central location. In some embodiments, the customer may indicate a need to purchase a plurality of the selected product. In this instance, the system may determine to ship the product to the customer from more than one of the alternative merchant locations.

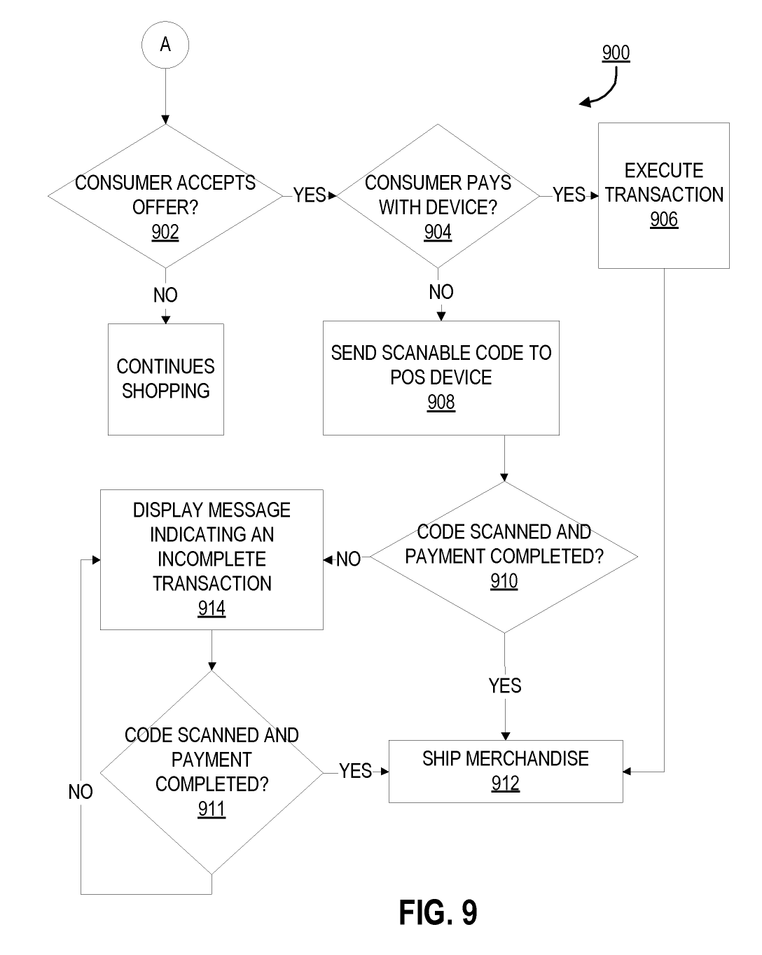

Referring now to FIG. 9, a block diagram illustrating a method for processing a transaction 900, according to an embodiment of the present invention, is provided. A consumer 102 may first accept an offer 902. In the instance that the consumer 102 accepts the offer, the consumer 102 may pay for the purchase using the device 904 in which the offer was accepted. For example, the consumer 102 may be presented one or more offers on a mobile device 104 via a consumer application 122 such that upon accepting at least one offer the consumer 102 may pay for the product of interest using the mobile device 104. If the transaction is successfully executed 906, the merchandise may be later shipped to the consumer, as illustrated in event 912. In an alternative embodiment, the consumer 102 may immediately receive the merchandise one the transaction has been successfully executed 906.

In the instance that the consumer 102 accepts the offer, the consumer 102 may also choose to not pay for the purchase using the device 904 in which the offer was accepted. In such an instance, a scannable code may be sent to the point-of-sale (POS) device 908. For example, the consumer 102 may be presented one or more offers on a mobile device 104 via a consumer application 122 such that upon accepting at least one offer a scannable code may be sent to the POS device. Upon scanning the code the payment for the product of interest may or may not be completed 910. If the payment is successfully completed, the merchandise may be later shipped to the consumer 102, as illustrated in event 912. In an alternative embodiment, the consumer 102 may immediately receive the merchandise one the payment has been successfully completed. If the payment is not successfully completed, the consumer 102 may be presented a message indicating the transaction is incomplete, as illustrated in event 914. For example, the consumer 102 may have chosen a method of payment with insufficient fund available such that the consumer 102 may be notified of the failed transaction and prompted to choose an alternative method of payment. The system may then again inquire whether or not the code has been scanned and the payment has been completed 911. Upon a second time, if the payment is successfully completed, the merchandise may be later shipped to the consumer 912. In an alternative embodiment, the consumer 102 may immediately receive the merchandise one the payment has been successfully completed. In a instance that the payments has not been completed the system reverts back to displaying an error message 914.

Any of the features described herein with respect to a particular process flow are also applicable to any other process flow. In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory or the like) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa.

What is claimed is:

1. An system for providing in-store merchandise offers, the apparatus comprising:
a memory;
a computer processing device; and
a module stored in the memory, executable by the computer processing device, and configured to:
receive an offer request from a consumer, wherein the offer request indicates the consumer's interest in purchasing one or more products exhibited at a merchant in an in-store merchandise showroom;
determine one or more offers based at least in part on the offer request, wherein determining the one or more offers comprises identifying, in an offer database, one or more offers associated with at least one product indicated in the offer request;
send the consumer the one or more offers in response to the offer request, wherein at least one of the one or more offers is related to a merchant independent of the merchant in-store merchandise showroom;
provide the consumer an option to select at least one offer, wherein selecting the at least one offer is equated to accepting one or more terms and conditions associated with the offer; and
receive the consumer's option selection.

2. The system of claim 1, wherein the module is further configured to:
send the offer request to a merchant, wherein the offer request is sent in response to the consumer scanning a code associated with the one or more products or manually inputting information associated with the one or more products; and
send competitor information to the merchant, wherein the competitor information includes the competitor price for the one or more products, and wherein the competitor information is associated with at least one in-store or online merchant independent of the in-store merchandise showroom where the one or more products are exhibited.

3. The system of claim 2, wherein sending the consumer one or more offers comprises the module being further configured to:
receive a merchant offer, wherein the merchant offer is determined based at least partially on the competitor information, and wherein determining the merchant offer comprises determining a product price less than the product price indicated in the competitor information or determining a purchase incentive not indicated in the competitor information; and
send the merchant offer to the consumer, wherein the offer provides details for at least one of a product price or purchase incentive.

4. The system of claim 1, wherein the module is further configured to:
individually display, on a mobile device associated with the consumer, the at least one offer such that the offer is accompanied by the option to select the offer.

5. The system of claim 1, wherein not selecting the at least one offer is associated with denying one or more terms and conditions associated with the offer.

6. The system of claim 1, wherein the consumer option selection indicates the consumer denied the one or more offers, and wherein the module is further configured to:
provide at least one merchant with information related to the denial of the one or more offers, wherein the at least one merchant includes the merchant; and
receive a second merchant offer, wherein the merchant determines the second merchant offer based at least partially on the information related to the denial of the one or more offers such that the second offer is subsequently sent to the consumer.

7. The system of claim 1, wherein sending the consumer one or more offers further comprises retrieving the one or more offers from the offer database located in the memory.

8. The system of claim 1, wherein the consumer specifies one or more user preferences for receiving offers, and wherein the user preferences are related to pricing, location, or product quality.

9. The system of claim 1, wherein the module is further configured to initiate a transaction in response to receiving the consumer option selection.

10. The system of claim 1, wherein the module is further configured to:
generate a transaction code based at least partially on the consumer option selection; and
send the transaction code to the consumer, wherein the transaction includes product and offer information, and wherein the transaction code is displayed on a mobile device associated with the consumer.

11. The system of claim 1, wherein the offer request is received in response to the consumer providing a code associated with the one or more products, wherein providing the code comprises scanning, using a mobile device, a form of visual indicia associated with the one or more products or manually inputting information associated with the one or more products.

12. The system of claim 1, wherein the in-store merchandise showroom is associated with one or more brick and mortar merchant locations such that the customer can physically interact with the one or more products of interest.

13. A computer-implemented method for providing in-store merchandise offers, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
receiving, using a computer processing device, an offer request from a consumer, wherein the offer request indicates the consumer's interest in purchasing one or more products exhibited in an in-store merchandise showroom;
sending the consumer one or more offers based at least partially on the offer request, wherein at least one of the one or more offers is related to a merchant not associated with of the merchandise showroom;
providing, at a mobile device, the consumer an option to select at least one offer, wherein selecting the at least one offer is equated to accepting one or more terms and conditions associated with the offer, and where not selecting the at least one offer is associating with denying one or more terms and conditions associated with the offer; and
receiving the consumers option selection.

14. The computer-implemented method of claim 13, the method further comprising:
sending the offer request to a merchant; and
sending competitor information to the merchant, wherein the competitor information includes the competitor price for the one or more products.

15. The computer-implemented method of claim 13, wherein sending the consumer one or more offers further comprises:
receiving a merchant offer, wherein the merchant offer is determined based at least partially on the competitor information; and
sending the merchant offer to the consumer.

16. The computer-implemented method of claim 13, the method further comprising:
generating a transaction code based at least partially on the consumer option selection; and
sending the transaction code to the consumer, wherein the transaction includes product and offer information, and wherein the transaction code is displayed on a mobile device associated with the consumer.

17. A computer program product for providing in-store merchandise offers, the computer program product comprising:
a non-transitory computer-readable medium comprising a set of codes for causing a computer to:
receive an offer request from a consumer, wherein the offer request indicates the consumer's interest in purchasing one or more products exhibited in an in-store merchandise showroom;
send the consumer one or more offers based at least partially on the offer request, wherein at least one of the one or more offers is related to a merchant not associated with of the merchandise showroom;
provide the consumer an option to select at least one offer, wherein selecting the at least one offer is equated to accepting one or more terms and conditions associated with the offer, and where not selecting the at least one offer is associating with denying one or more terms and conditions associated with the offer; and
receive the consumers option selection.

18. The computer program product of claim 17, further comprising a set of codes for causing a computer to:
send the offer request to a merchant; and
send competitor information to the merchant, wherein the competitor information includes the competitor price for the one or more products.

19. The computer program product of claim 17, further comprising a set of codes for causing a computer to:
receive a merchant offer, wherein the merchant offer is determined based at least partially on the competitor information; and
send the merchant offer to the consumer.

20. The computer program product of claim 17, further comprising a set of codes for causing a computer to:
generate a transaction code based at least partially on the consumer option selection; and
send the transaction code to the consumer, wherein the transaction includes product and offer information, and wherein the transaction code is displayed on a mobile device associated with the consumer.
